(19) United States
(12) Patent Application Publication
(10) Pub. No.: US 2006/0121356 A1
(43) Pub. Date: Jun. 8, 2006

(54) Electrolyte for rechargeable battery

(75) Inventors: Yih-Song Jan, Taipei City (TW); Lun-Chien Ho, Taichung City (TW); Shr-Ming Li, Chiayi City (TW); Tsung-Ting Hsieh, Hsinchu City (TW); Wen-Yuan Chuang, Taipei County (TW)

Correspondence Address: BROWDY AND NEIMARK, P.L.L.C.;624 NINTH STREET, NW, SUITE 300, WASHINGTON, DC, 20001-5303, US

(73) Assignee: Exa Energy Technology Co. Ltd., Taichung (TW)

(21) Appl. No.: 11/004,812

(22) Filed: Dec. 7, 2004

(51) Int. Cl. H01M 10/40

(52) U.S. Cl. 429/331; 429/332

(57) ABSTRACT

An electrolyte for a rechargeable battery includes 20-70% by volume of at least two cyclic carbonates selected from ethylene carbonate, propylene carbonate, vinylene carbonate or butylenes carbonate, 30-80% by volume of an ester selected from propyl propionate, propyl acetate, butyl acetate or a mixture thereof, and a lithium salt.

### BACKGROUND OF THE INVENTION

1. Field of the Invention

The present invention relates to a rechargeable battery and more particularly, to an electrolyte for a rechargeable battery that enables the rechargeable battery to have a relatively higher capacity, relatively better discharge property, relatively better low-temperature characteristics, and a relatively longer cycle life.

2. Description of the Related Art

The electrolyte for a regular commercially available rechargeable battery is generally composed of cyclic carbonates, for example, ethylene carbonate (EC) or propylene carbonate (PC), a linear carbonate, for example, diethyl carbonate (DEC), and a lithium salt, for example, LiPF₆. The electrolyte is used with a positive electrode prepared from LiCoO₂ and a negative electrode prepared from Li—C to form a quality acceptable rechargeable battery.

The aforesaid electrolyte is expensive, and not perfect for use to make a battery. Battery suppliers are trying hard to find other substitutes for making an inexpensive rechargeable battery having improved characteristics.

### SUMMARY OF THE INVENTION

It is the primary objective of the present invention to provide an electrolyte, which is practical for use to make a rechargeable battery having a relatively higher capacity, relatively better discharge property, relatively better low-temperature characteristics, and a relatively better cycle life.

It is another objective of the present invention to provide an electrolyte, which is greatly reduces the manufacturing cost of the rechargeable battery.

To achieve the above-mentioned objectives of the present invention, the electrolyte for a rechargeable battery provided by the present invention comprises a mixture of at least two cyclic carbonates, an ester and a lithium salt. The electrolyte includes preferably 20-70%, and more preferably 40-60%, by volume of the mixture of the cyclic carbonates, and 30-80%, and more preferably 40-60%, by volume of the ester.

For the mixture of the cyclic carbonates, a mixture of two or more compounds selected from ethylene carbonate (EC), propylene carbonate (PC), vinylene carbonate (VC) or butylenes carbonate (BC) can be used. For the ester, propyl propionate, propyl acetate, butyl acetate or a mixture thereof can be used. For the lithium salt, lithium hexafluorophosphate (LiPF₆), lithium hexafluoroasenate (LiAsF₆), lithium percholate (LiClO₄), lithium tetrafluoroborate (LiBF₄), lithium trifluoromethanesulfonate (CF₃SOLi) or a mixture thereof can be used. Preferably, the concentration of the lithium salt is 0.5 to 2.0M.

### DETAILED DESCRIPTION OF THE INVENTION

For fully understanding of the compositions and features of the present invention, three examples are described hereinafter.

The invention uses an ester such as propyl propionate (PP), propyl acetate (PA), or butyl acetate (BA) to substitute for the diethyl carbonate (DEC) that is widely used in the conventional electrolyte for a rechargeable lithium battery, thereby improving the properties of the electrolyte, i.e., the invention uses an ester of low viscosity to substitute the linear carbonate while maintaining the cyclic carbonate and lithium salt that are used in the conventional electrolyte for a rechargeable battery, so as to form an electrolyte having improved properties.

According to the conventional design, ethylene carbonate (EC), propylene carbonate (PC), and diethyl carbonate (DEC) were mixed at the ratio by volume of 3:2:5, and then 2wt % vinylene carbonate (VC) is added to the mixture, and then LiPF₆ as lithium salt was added to the mixture thus obtained to a concentration of 1.1M. 2.2 g of the conventional electrolyte was used with a positive electrode of LiCoO₂ and a negative electrode of meso carbon micro beads (MCMB) to form a conventional rechargeable battery as a Comparative Example.

### EXAMPLE 1

Ethylene carbonate (EC), propylene carbonate (PC), and propyl propionate (PP) were mixed at the ratio by volume of 3:2:5, and then 2wt % vinylene carbonate (VC) was added to the mixture, and then LiPF₆ as lithium salt was added to the mixture thus obtained to concentration of 1.1M. 2.2 g of the electrolyte thus obtained was used with a positive electrode of LiCoO₂ and a negative electrode of MCMB carbon material to form a rechargeable battery as the Example 1.

The aforesaid Comparative Example and the Example 1 were tested through a battery analyzer, and the test result is listed as follows.

TABLE 1

| | Comparative Example | Example 1 |
|---|---|---|
| Composition (by volume) | EC:PC:DEC = | EC:PC:PP = |
| (Solute: 1.1M LiPF₆) | 3:2:5 | 3:2:5 |
| | 2 wt % VC | 2 wt % VC |
| Capacity [mAh] (0.2C) | 680 | 682 |
| Discharge current property | 67.5% | 77.4% |
| (C-rate) (3.0C/0.2C) | | |
| Low temperature capacity | 82% | 87% |
| (−20° C./Room temperature) | | |
| Cycle life (100 times) | 95% | 95.2% |

As shown in table 1, Example 1 has a relatively higher capacity than Comparative Example, and the Example 1 is about 10% higher than the Comparative Example in C-rate that is a common reference for indicating the discharge and charge current of a battery, i.e., the Example 1 maintains a relatively higher proportion of capacity than the Comparative Example during a current discharging action. With respect to the low temperature capacity, the Example 1 surpasses the Comparative Example about 5%, i.e., the Example 1 shows a better performance than the Comparative Example under a low temperature condition. With respective to the cycle life, the Example 1 is also superior to the Comparative Example.

In general, in comparison to a rechargeable battery made according to the prior art design, the rechargeable battery of Example 1 has a relatively greater capacity, relatively better discharge property, relatively better low-temperature characteristics, and a relatively longer cycle life. Further, because propyl propionate (PP) is less expensive than diethyl carbonate (DEC), Example 1 has the advantage of low manufacturing cost.

### EXAMPLE 2

EC (ethylene carbonate), PC (propylene carbonate), and PA (propyl acetate) were mixed at the ratio by volume of 3:2:5, and then 2wt % VC (vinylene carbonate) was added to the mixture, and then LiPF₆ as lithium salt was added to the mixture thus obtained to the concentration of 1.1M. 2.4 g of the electrolyte thus obtained was used with a positive electrode of LiCoO₂ and a negative electrode of MCMB carbon material to form a rechargeable battery Example 2.

The aforesaid Comparative Example and the Example 2 were tested through a battery analyzer, and the test result is listed as follows.

TABLE 2

| | Comparative Example | Example 2 |
|---|---|---|
| Composition (by volume) | EC:PC:DEC = | EC:PC:PA = |
| (Solute: 1.1M LiPF₆ | 3:2:5 | 3:2:5 |
| | 2 wt % VC | 2 wt % VC |
| Capacity [mAh] (0.2C) | 680 | 695 |
| Discharge current property | 68% | 94.3% |
| (C-rate) (3.0C/0.2C) | | |
| Low temperature capacity | 82% | 87.2% |
| (−20° C./Room temperature) | | |
| Cycle life (100 times) | 95% | 93% |

As shown in table 2, the Example 2 has a capacity about 15 mAh higher than the Comparative Example; the Example 2 is about 26% higher than Comparative Example in C-rate, i.e., the Example 2 maintains a relatively higher proportion of capacity than the Comparative Example during a current discharging action and the capacity at 3 C can be as high as about 94.3% of the capacity at 0.2 C, showing an excellent performance. With respect to the low-temperature capacity, the Example 2 surpasses the Comparative Example about 5%, i.e., the Example 2 shows a better performance than the Comparative Example under a low temperature condition. With respective to the cycle life, the Example 2 is slightly inferior to the Comparative Example.

In general, in comparison to a rechargeable battery made according to the prior art design, the rechargeable battery made by the Example 2 of the present invention has a relatively greater capacity, relatively better discharge property and relatively better low-temperature characteristics. Further, because PA (propyl acetate) is less expensive than DEC (diethyl carbonate), Example 2 has the advantage of low manufacturing cost.

### EXAMPLE 3

EC (ethylene carbonate), PC (propylene carbonate), and BA (butyl acetate) were mixed at the ratio by volume of 3:2:5, and then 2wt % VC (vinylene carbonate) was added to the mixture, and then LiPF₆ as lithium salt was added to the mixture thus obtained to the concentration of 1.3M. 3.0 g of the electrolyte thus obtained was used with a positive electrode of LiCoO₂ and a negative electrode of MCMB carbon material to form a rechargeable battery Example 3.

The aforesaid Comparative Example and the Example 3 were tested through a battery analyzer, and the test result is listed as follows.

TABLE 3

| | Comparative Example | Example 3 |
|---|---|---|
| Composition (by volume) | EC:PC:DEC = | EC:PC:BA = |
| (Solute: 1.3M LiPF₆) | 3:2:5 | 3:2:5 |
| | 2 wt % VC | 2 wt % VC |
| Capacity [mAh] (0.2C) | 723 | 742 |
| Discharge current property | 89.8% | 94.1% |
| (C-rate) (3.0C/1C) | | |
| Low temperature capacity | 79.6% | 87.1% |
| (−20° C./Room temperature) | | |
| Cycle life (100 times) | 95% | 95% |

As shown in table 3, the Example 3 has a capacity about 19 mAh higher than the Comparative Example; the Example 3 is about 4.3% higher than the Comparative Example in C-rate, i.e., the Example 3 maintains a relatively higher proportion of capacity than the Comparative Example during a current discharging action. With respect to the low temperature capacity, the Example 3 surpasses the Comparative Example about 7.5%, i.e., the Example 3 shows a better performance than the Comparative Example under a low temperature condition. With respect to the cycle life, the Example 3 and the Comparative Example show no difference.

In general, in comparison to a rechargeable battery made according to the prior art design, a rechargeable battery made according to the Example 3 has a relatively greater capacity, relatively better discharge property and relatively better low-temperature characteristics. Further, because BA (butyl acetate) is less expensive than DEC (diethyl carbonate) and takes about 50% of the total volume of the electrolyte, the Example 3 has the advantage of low manufacturing cost to be highly competitive in the market.

In conclusion, the invention uses an ester of relatively lower viscosity to substitute for the linear carbonate that is used in the conventional electrolyte. In addition to EC (ethylene carbonate), PC (propylene carbonate), and VC (vinylene carbonate) for cyclic carbonate, BC (butylenes carbonate) can be used too. In fact, any two or more of a variety of cyclic carbonate compounds may be used. With respect to the ester, PP (propyl propionate), PA (propyl acetate), BA (butyl acetate), or a mixture thereof can be used. With respect to the proportion, the cyclic carbonate can have the volume of 20-70%, and the ester can have the volume of 30-80%. The lithium salt can be selected from LiPF₆ (lithium hexafluorophosphate), LiAsF₆ (lithium hexafluoroasenate), LiClO₄ (lithium percholate), LiBF₄ (lithium tetrafluoroborate), CF₃SOLi (lithium trifluoromethanesulfonate), or a mixture thereof. The concentration of the lithium salt can be within about 0.5-2.0M.

What is claimed is:

1. An electrolyte for a rechargeable battery comprising:
20-70% by volume of at least two cyclic carbonates selected from the group consisting of ethylene carbonate, propylene carbonate, vinylene carbonate and butylenes carbonate;
30-80% by volume of an ester selected from the group consisting of propyl propionate, propyl acetate, butyl acetate, and a mixture thereof; and
a lithium salt.

2. The electrolyte of claim 1, wherein the electrolyte includes 40 to 60% by volume of the cyclic carbonates and 40 to 60% by volume of the ester.

3. The electrolyte of claim 1, wherein the lithium salt is selected from the group consisting of lithium hexafluorophosphate (LiPF₆), lithium hexafluoroasenate (LiAsF₆), lithium percholate (LiClO₄), lithium tetrafluoroborate (LiBF₄), lithium trifluoromethanesulfonate (CF₃SOLi), and a mixture thereof.

4. The electrolyte of claim 1, wherein the concentration of the lithium salt is 0.5 to 2.0M.
